(19) United States
(12) Patent Application Publication
(10) Pub. No.: US 2005/0058275 A1
(43) Pub. Date: Mar. 17, 2005

(54) Audio source identification

(76) Inventors: Jun Shi, San Jose, CA (US); Animesh Mishra, Pleasanton, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/661,314

(22) Filed: Sep. 12, 2003

(51) Int. Cl. H04M 1/00; H04M 3/42; H04M 3/00

(52) U.S. Cl. 379/386

(57) ABSTRACT

In one embodiment, a method is provided. The method of this embodiment may include issuing and/or receiving one or more signals encoding audio information and/or an identification of a source of the audio information. The audio information may be generated, at least in part, at the source. The identification may be generated based, at least in part upon, identifying information provided at the source. Of course, many alternatives, variations, and modifications are possible without departing from this embodiment.

### FIELD

This disclosure relates to audio source identification.

### BACKGROUND

In one conventional audio teleconferencing arrangement, a public switched telephone network (PSTN) telephonically bridges a plurality of telephone connections in such a way as to enable teleconference participants to communicate contemporaneously with each other via the PSTN. Depending upon factors, such as, for example, each participant's familiarity with the other participants′ voices and speech patterns, and the connection quality and/or performance of the PSTN during the teleconference, it may be difficult for the participants to identify correctly a teleconference participant speaking in the teleconference. Additionally, one or more teleconference participants may not speak during the teleconference. Unless these non-speaking teleconference participants are identified during the teleconference as being teleconference participants, other teleconference participants may be unaware that the non-speaking participants are actually teleconference participants. These issues may result in confusion during the teleconference, and may make the teleconference experience frustrating, less productive, and less efficient.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a diagram that illustrates an embodiment of a network system.

FIG. 2 is a diagram that illustrates an embodiment of a computer system.

FIG. 3 is a diagram that illustrates another embodiment of a computer system.

FIG. 4 is a flowchart that illustrates operations that may be performed according to an embodiment.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

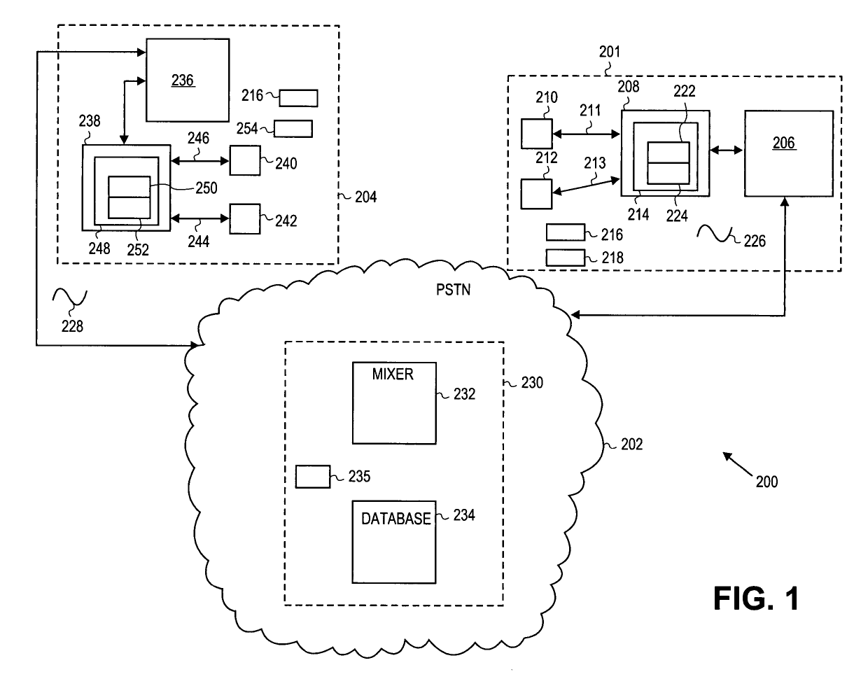

FIG. 1 is a diagram of an embodiment of a network system 200. System 200 may comprise a plurality of sites (e.g., sites 201 and 204) that are communicatively coupled together via a network 202. In this embodiment network 202 may be a public telephone network, such as, for example, a PSTN, although without departing from this embodiment, network 202 may comprise other types of networks.

In this embodiment, site 201 may comprise a computer system 206 that is communicatively coupled to a telephone system 208, and a plurality of microphone devices (e.g., microphone devices 210 and 212) that are communicatively coupled to telephone system 208 via respective communication links 211 and 213. In this embodiment, telephone 208 may comprise operative circuitry 214. As used herein, “circuitry” may comprise, for example, singly or in any combination, hardwired circuitry, programmable circuitry, state machine circuitry, and/or memory that may comprise program instructions that may be executed by programmable circuitry.

Circuitry 214 may be capable of operating as a wireless base station, links 211 and 213 may comprise wireless communication links, and microphone devices 210 and 212 may be capable of wirelessly communicating with telephone 208 via links 211 and 213, respectively. As used herein, a first device is said to be capable of “wireless communication” with a second device, if the first device is capable of transmitting to and/or receiving from the second device one or more signals, at least partially without the use of a wire, cable, or other wired medium as a propagation medium for the one or more signals between the first device and the second device.

In this embodiment, circuitry 214 may comprise, for example, keypad 222 and speaker 224. As is discussed below, in this embodiment, microphones 210 and 212 may be held by these users, and/or may attached via suitable means (not shown) to, for example, clothing worn by the users, in such a way as to permit one or more ambient sound waves generated, for example, by and/or as a result of the users' respective speech, to be detected by the microphones 210 and 212. Microphones 210 and 212 may convert the one or more detected sound waves into one or more corresponding signals that may be transmitted to telephone 208 via links 211 and 213. These one or more corresponding signals generated by microphones 210 and 212 may encode audio information representing the one or more sound waves detected by the microphones 210 and 212. As used herein, “audio information” means one or more symbols and/or values that may represent, at least in part, one or more audible phenomena, such as, for example, in this embodiment, one or more sound waves generated by and/or as a result of the user speech and the volume and/or loudness of such sound waves. Thus, in this embodiment, if, for example, microphone 212 detects one or more sound waves generated by and/or as a result of a user's speech, microphone 212 may generate and issue to telephone system 208 via link 213 one or more signals that may encode audio information 216 that may represent, at least in part, these one or more detected sound waves and the volume and/or loudness of such sound waves.

Additionally, in this embodiment, each of the microphones 210 and 212 may be associated with respective identifying information. As used herein, “identifying information” means data based upon, and/or from which an identification may be made, at least in part. In this embodiment, each respective microphone 210 and 212 may transmit to telephone 208 respectively via links 211 and 213, respective identifying information, such as, for example, a respective identification code previously associated with the respective microphone. These respective identification codes may comprise, for example, respective addresses assigned to the respective microphones.

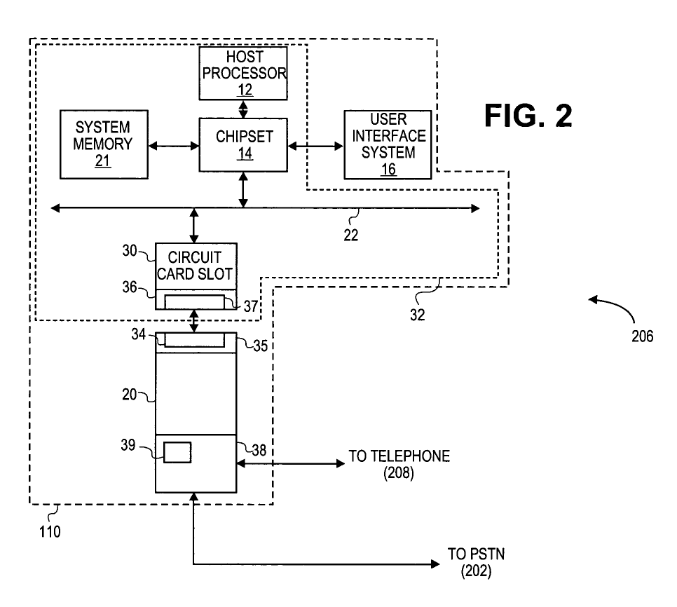

Alternatively, or additionally, telephone system 208 may assign, at least in part, the respective identification codes to the respective microphones, based at least in part upon one or more alpha-numeric messages entered by one or more users via keypad 222 and/or user interface system 16 of system 206 (see FIG. 2). As used herein, an “alpha-numeric message” means one or more alphabetical characters, one or more numerical characters, one or more symbols, and/or one or more ideograms. In this embodiment, these one or more alpha-numeric messages may comprise, for example, one or more names of one or more users to which the microphones 210 and 212 may be attached, one or more names of the site 201, and/or one or more preset codes associated with one or more such names. The users at site 201 may receive prompts and/or requests to enter respective alpha-numeric messages to be associated with each such user and/or microphone 210 and 212 in the form of, for example, one or more audible and/or visual commands and/or request prompts generated by speaker 224 and/or user interface system 16 of system 206. Of course, many variations are possible without departing from this embodiment.

For example, the human user to whom microphone 212 may be attached, may provide at telephone 208 identifying information by entering one or more alpha-numeric messages via keypad 222 and/or user interface system 16 of system 206 that may identify, at least in part, a source of audio information 216, in terms of one or more names of the human user and/or site 201, and/or one or more preset codes associated with these one or more names. Alternatively, microphone 212 may provide to telephone 208 via link 213 identifying information in the form of an identification code identifying, at least in part, a source of audio information 216. As used herein, an entity may be a “source” of audio information, if the entity generates, issues, and/or transmits the audio information, at least in part.

Without departing from this embodiment, each of the microphones 210 and/or 212 may comprise, for example, a telephonic headset (not shown) comprising a microphone and speaker (not shown) wearable by a human user. Additionally or alternatively, link 211 and/or link 213 may comprise one or more wired links (not shown) that may communicatively couple microphone 210 and/or microphone 212 to telephone 208.

Also, alternatively, without departing from this embodiment, microphone 210 and/or microphone 212, and/or its corresponding link 211 and/or 213 may be eliminated. In this alternative arrangement, telephone system 208 may comprise one or more microphones (not shown) that may be capable of detecting ambient sound waves and generating audio information 216. Many alternatives and variations are possible without departing from this embodiment.

In this embodiment, site 204 may comprise a computer system 236 that is communicatively coupled to a telephone system 238, and a plurality of microphone devices (e.g., microphone devices 240 and 242) that are communicatively coupled to telephone system 238 via respective communication links 246 and 244. In this embodiment, telephone 238 may comprise operative circuitry 248. Circuitry 248 may be capable of operating as a wireless base station, links 246 and 244 may comprise wireless communication links, and microphone devices 240 and 242 may be capable of wirelessly communicating with telephone 238 via links 246 and 244, respectively.

In this embodiment, circuitry 248 may comprise, for example, keypad 250 and speaker 252. As is discussed below, in this embodiment, microphones 240 and 242 may be held by these users, and/or may attached via suitable means (not shown) to, for example, clothing worn by the users, in such a way as to permit one or more ambient sound waves generated, for example, by and/or as a result of the users' respective speech, to be detected by the microphones 240 and 242. Microphones 240 and 242 may convert the one or more detected sound waves into one or more corresponding signals that may be transmitted to telephone 238 via links 246 and 244. These one or more corresponding signals generated by microphones 240 and 242 may encode audio information representing the one or more sound waves detected by the microphones 240 and 242. Thus, in this embodiment, if, for example, microphone 240 detects one or more sound waves generated by and/or as a result of a user's speech, microphone 240 may generate and issue to telephone system 238 via link 246 one or more signals that may encode audio information that may represent, at least in part, these one or more detected sound waves.

Additionally, in this embodiment, each of the microphones 240 and 242 may be associated with respective identifying information. In this embodiment, each respective microphone 240 and 242 may transmit to telephone 238 respectively via links 246 and 244, respective identifying information, such as, for example, a respective identification code previously associated with the respective microphone. These respective identification codes may comprise, for example, respective addresses assigned to the respective microphones.

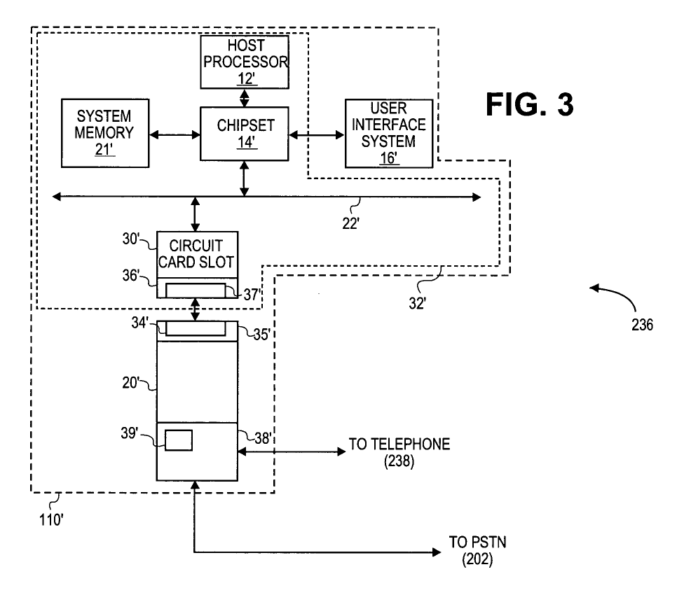

Alternatively, or additionally, telephone system 238 may assign, at least in part, the respective identification codes to the respective microphones, based at least in part upon one or more alpha-numeric messages entered by one or more users via keypad 250 and/or user interface system 16′ of system 236 (see FIG. 3). In this embodiment, these one or more alpha-numeric messages may comprise, for example, one or more names of one or more users to which the microphones 240 and 242 may be attached, one or more names of the site 204, and/or one or more preset codes associated with one or more such names. The users at site 204 may receive prompts and/or requests to enter respective alpha-numeric messages to be associated with each such user and/or microphone 240 and 242 in the form of, for example, one or more audible and/or visual commands and/or request prompts generated by speaker 252 and/or user interface system 16′ of system 236 (see FIG. 3). Of course, many variations are possible without departing from this embodiment.

For example, the human user to whom microphone 242 may be attached, may provide at telephone 238 identifying information by entering one or more alpha-numeric messages via keypad 250 and/or user interface system 16′ that may identify, at least in part, one or more sources of respective audio information generated at site 204, in terms of one or more names of the human user and/or site 204, and/or one or more preset codes associated with these one or more names. Alternatively, microphone 242 may provide to telephone 238 via link 244 identifying information in the form of an identification code identifying, at least in part, one or more sources of respective audio information.

Without departing from this embodiment, each of the microphones 240 and/or 242 may comprise, for example, a telephonic headset (not shown) comprising a microphone and speaker (not shown) wearable by a human user. Additionally or alternatively, link 246 and/or link 244 may comprise one or more wired links (not shown) that may communicatively couple microphone 240 and/or microphone 242 to telephone 238.

Also, alternatively, without departing from this embodiment, microphone 240 and/or microphone 242, and/or its corresponding link 246 and/or 244 may be eliminated. In this alternative arrangement, telephone system 238 may comprise one or more microphones (not shown) that may be capable of detecting ambient sound waves and generating audio information. Many alternatives and variations are possible without departing from this embodiment.

PSTN 202 may comprise one or more intermediate nodes 230 that may comprise, for example, mixer circuitry 232, database 234, and computer-readable memory 235. Memory 235 may comprise one or more of the following types of memories: semiconductor firmware memory, programmable memory, non-volatile memory, read only memory, electrically programmable memory, random access memory, flash memory, magnetic disk memory, and/or optical disk memory. Either additionally or alternatively, memory 235 may comprise other and/or later-developed types of computer-readable memory.

Machine-readable program instructions may be stored in memory 235. These instructions may be accessed and executed by one or more intermediate nodes 230, mixer 232, and/or database 234. When executed by one or more intermediate nodes 230, mixer 232, and/or database 234, these instructions may result in PSTN 202, one or more intermediate nodes 230, mixer 232, and/or database 234 performing the operations described herein as being performed by PSTN 202, one or more intermediate nodes 230, mixer 232, and/or database 234.

Of course, without departing from this embodiment, PSTN 202, database 234, and/or mixer 232 may comprise respective not shown program memories. Additionally or alternatively, mixer 232 and/or database 234 may not be comprised in one or more intermediate nodes 230, and/or may be (but are not required to be) geographically and/or physically separated from each other. Further additionally or alternatively, database 234 may comprise a combination of hardware and software components, and/or may comprise memory 235. Also, without departing from this embodiment, PSTN 202 may comprise a PSTN and/or a not shown data communication network. This data communication network may permit nodes 206 and 236 to exchange packets, in accordance with conventional voice-over-internet protocol techniques, that may comply and/or be compatible with an internet protocol, such as for example, the Internet Protocol described in Request For Comments 791, published by The Internet Engineering Task Force, September 1981. Many other and/or additional variations, modifications, and alternatives are possible without departing from this embodiment.

FIG. 2 is a diagram of computer system 206. System 206 may include a host processor 12 coupled to a chipset 14. Host processor 12 may comprise, for example, an Intel® Pentium® IV microprocessor that is commercially available from the Assignee of the subject application. Of course, alternatively, host processor 12 may comprise another type of microprocessor, such as, for example, a microprocessor that is manufactured and/or commercially available from a source other than the Assignee of the subject application, without departing from this embodiment.

Chipset 14 may comprise a host bridge/hub system that may couple host processor 12, a system memory 21 and a user interface system 16 to each other and to a bus system 22. Chipset 14 may also include an input/output (I/O) bridge/hub system (not shown) that may couple the host bridge/bus system to bus 22. Chipset 14 may comprise one or more integrated circuit chips, such as those selected from integrated circuit chipsets commercially available from the assignee of the subject application (e.g., graphics memory and I/O controller hub chipsets), although one or more other integrated circuit chips may also, or alternatively be used, without departing from this embodiment. User interface system 16 may comprise, e.g., a keyboard, pointing device, and display system that may permit a human user to input commands to, and monitor the operation of, system 206.

Bus 22 may comprise a bus that complies with the Peripheral Component Interconnect (PCI) Express™ Base Specification Revision 1.0, published Jul. 22, 2002, available from the PCI Special Interest Group, Portland, Oreg., U.S.A. (hereinafter referred to as a “PCI Express™ bus”). Alternatively, bus 22 instead may comprise a bus that complies with the PCI-X Specification Rev. 1.0a, Jul. 24, 2000, available from the aforesaid PCI Special Interest Group, Portland, Oreg., U.S.A. (hereinafter referred to as a “PCI-X bus”). Also alternatively, bus 22 may comprise other types and configurations of bus systems, without departing from this embodiment.

Processor 12, system memory 21, chipset 14, bus 22, and circuit card slot 30 may be comprised in a single circuit board, such as, for example, a system motherboard 32. Host computer system operative circuitry 110 may comprise system motherboard 32, interface system 16, and circuit card 20.

Depending upon, for example, whether bus 22 comprises a PCI Express™ bus or a PCI-X bus, circuit card slot 30 may comprise, for example, a PCI Express™ or PCI-X bus compatible or compliant expansion slot or interface 36. Interface 36 may comprise a bus connector 37 may be electrically and mechanically mated with a mating bus connector 34 that may be comprised in a bus expansion slot or interface 35 in circuit card 20.

In this embodiment, circuit card 20 may comprise operative circuitry 38 which may comprise computer-readable memory 39. Memory 39 and/or memory 21 may comprise one or more of the following types of memories: semiconductor firmware memory, programmable memory, non-volatile memory, read only memory, electrically programmable memory, random access memory, flash memory, magnetic disk memory, and/or optical disk memory. Either additionally or alternatively, memory 39 and/or memory 21 may comprise other and/or later-developed types of computer-readable memory.

Machine-readable program instructions may be stored in memory 39 and/or memory 21. These instructions may be accessed and executed by processor 12, operative circuitry 110, and/or operative circuitry 38. When executed by processor 12, circuitry 110, and/or circuitry 38, these instructions may result in system 206, card 20, circuitry 110 and/or circuitry 38 performing the operations described herein as being performed by system 206, card 20, circuitry 110, and/or circuitry 38.

Slot 30 and card 20 are constructed to permit card 20 to be inserted into slot 30. When card 20 is properly inserted into slot 30, connectors 34 and 36 become electrically and mechanically coupled to each other. When connectors 34 and 36 are so coupled to each other, circuitry 38 in card 20 is electrically coupled to bus 22 and may exchange data and/or commands with system memory 21, host processor 12, and/or user interface system 16 via bus 22 and chipset 14.

Alternatively, without departing from this embodiment, operative circuitry 38 may not be comprised in card 20, but instead, may be comprised in other structures, systems, and/or devices. These other structures, systems, and/or devices may be, for example, comprised in motherboard 32, coupled to bus 22, and exchange data and/or commands with other components (such as, for example, system memory 21, host processor 12, and/or user interface system 16) in operative circuitry 110. For example, without departing from this embodiment, operative circuitry 38 may be comprised, at least in part, in chipset 14.

Also alternatively, without departing from this embodiment, at least a portion of operative circuitry 214 may not be comprised in telephone system 208, but instead, may be comprised in other structures, systems, and/or devices that may be, for example, comprised in operative circuitry 110 and/or circuitry 38, and may exchange data and/or commands with other components (such as, for example, system memory 21, host processor 12, and/or user interface system 16). Further alternatively, without departing from this embodiment, these other structures, systems, and/or devices may be, for example, comprised in another circuit card (not shown) that may coupled to bus 22 via another circuit card slot (not shown) that may be comprised in operative circuitry 110. In these alternative arrangements, telephone system 208 may be eliminated, and system 206 may receive audio information and identifying information from microphones 210 and 212 via links 211 and 213.

Further alternatively, without departing from this embodiment, at least a portion of operative circuitry 110 and/or circuitry 38 may not be comprised in system 206, but instead, may be comprised in other structures, systems, and/or devices that may be, for example, comprised in operative circuitry 214, and may exchange data and/or commands with other components (such as, for example, keypad 222 and speaker 224). In this alternative arrangement, system 206 may be eliminated, and telephone system 208 may be communicatively coupled to PSTN 202.

FIG. 3 is a diagram of computer system 236. System 236 may include a host processor 12′ coupled to a chipset 14′. Host processor 12′ may comprise, for example, an Intel® Pentium® IV microprocessor that is commercially available from the Assignee of the subject application. Of course, alternatively, host processor 12′ may comprise another type of microprocessor, such as, for example, a microprocessor that is manufactured and/or commercially available from a source other than the Assignee of the subject application, without departing from this embodiment.

Chipset 14′ may comprise a host bridge/hub system that may couple host processor 12′, a system memory 21′ and a user interface system 16 to each other and to a bus system 22′. Chipset 14′ may also include an input/output (I/O) bridge/hub system (not shown) that may couple the host bridge/bus system to bus 22′. Chipset 14′ may comprise one or more integrated circuit chips, such as those selected from integrated circuit chipsets commercially available from the assignee of the subject application (e.g., graphics memory and I/O controller hub chipsets), although one or more other integrated circuit chips may also, or alternatively be used, without departing from this embodiment. User interface system 16′ may comprise, e.g., a keyboard, pointing device, and display system that may permit a human user to input commands to, and monitor the operation of, system 236.

Bus 22′ may comprise a bus that complies with the Peripheral Component Interconnect (PCI) Express™ Base Specification Revision 1.0, published Jul. 22, 2002, available from the PCI Special Interest Group, Portland, Oreg., U.S.A. (hereinafter referred to as a “PCI Express™ bus”). Alternatively, bus 22′ instead may comprise a bus that complies with the PCI-X Specification Rev. 1.0a, Jul. 24, 2000, available from the aforesaid PCI Special Interest Group, Portland, Oreg., U.S.A. (hereinafter referred to as a “PCI-X bus”). Also alternatively, bus 22′ may comprise other types and configurations of bus systems, without departing from this embodiment.

Processor 12′, system memory 21′, chipset 14′, bus 22′, and circuit card slot 30′ may be comprised in a single circuit board, such as, for example, a system motherboard 32′. Host computer system operative circuitry 110′ may comprise system motherboard 32′, interface system 16′, and circuit card 20′.

Depending upon, for example, whether bus 22′ comprises a PCI Express™ bus or a PCI-X bus, circuit card slot 30′ may comprise, for example, a PCI Express™ or PCI-X bus compatible or compliant expansion slot or interface 36′. Interface 36′ may comprise a bus connector 37′ may be electrically and mechanically mated with a mating bus connector 34′ that may be comprised in a bus expansion slot or interface 35′ in circuit card 20′.

In this embodiment, circuit card 20′ may comprise operative circuitry 38′ which may comprise computer-readable memory 39′. Memory 39′ and/or memory 21′ may comprise one or more of the following types of memories: semiconductor firmware memory, programmable memory, non-volatile memory, read only memory, electrically programmable memory, random access memory, flash memory, magnetic disk memory, and/or optical disk memory. Either additionally or alternatively, memory 21 ′ and/or memory 39′ may comprise other and/or later-developed types of computer-readable memory.

Machine-readable program instructions may be stored in memory 39′ and/or memory 21′. These instructions may be accessed and executed by processor 12′, operative circuitry 110′, and/or operative circuitry 38′. When executed by processor 12′, circuitry 110′, and/or circuitry 38′, these instructions may result in system 236, card 20′, circuitry 110′ and/or circuitry 38′ performing the operations described herein as being performed by system 236, card 20′, circuitry 110′, and/or circuitry 38′.

Slot 30′ and card 20′ are constructed to permit card 20′ to be inserted into slot 30′. When card 20′ is properly inserted into slot 30′, connectors 34′ and 36′ become electrically and mechanically coupled to each other. When connectors 34′ and 36′ are so coupled to each other, circuitry 38′ in card 20′ is electrically coupled to bus 22′ and may exchange data and/or commands with system memory 21′, host processor 12′, and/or user interface system 16′ via bus 22′ and chipset 14′.

Alternatively, without departing from this embodiment, operative circuitry 38′ may not be comprised in card 20′, but instead, may be comprised in other structures, systems, and/or devices. These other structures, systems, and/or devices may be, for example, comprised in motherboard 32′, coupled to bus 22′, and exchange data and/or commands with other components (such as, for example, system memory 21′, host processor 12′, and/or user interface system 16′) in operative circuitry 110′. For example, without departing from this embodiment, operative circuitry 38′ may be comprised, at least in part, in chipset 14′.

Also alternatively, without departing from this embodiment, at least a portion of operative circuitry 248 may not be comprised in telephone system 238, but instead, may be comprised in other structures, systems, and/or devices that may be, for example, comprised in operative circuitry 110′ and/or circuitry 38′, and may exchange data and/or commands with other components (such as, for example, system memory 21′, host processor 12′, and/or user interface system 16′). Further alternatively, without departing from this embodiment, these other structures, systems, and/or devices may be, for example, comprised in another circuit card (not shown) that may coupled to bus 22′ via another circuit card slot (not shown) that may be comprised in operative circuitry 110′. In these alternative arrangements, telephone system 238 may be eliminated, and system 236 may receive audio information and identifying information from microphones 240 and 242 via links 246 and 244.

Further alternatively, without departing from this embodiment, at least a portion of operative circuitry 110′ and/or circuitry 38′ may not be comprised in system 236, but instead, may be comprised in other structures, systems, and/or devices that may be, for example, comprised in operative circuitry 248, and may exchange data and/or commands with other components (such as, for example, keypad 250 and speaker 252). In this alternative arrangement, system 236 may be eliminated, and telephone system 238 may be communicatively coupled to network 202.

Of course, the number of users at sites 201 and/or 204, the number of sites in system 200, the number of microphones and associated links at each site, and the number of telephones at each site may vary without departing from this embodiment. Many modifications, variations, and alternatives are possible without departing from this embodiment.

With reference now being made to FIGS. 1-4, operations 300 that may be performed in accordance with an embodiment will be described. In this embodiment, after, prior to, or contemporaneously with establishment of a teleconference involving human user participants at sites 201 and 204, and after telephone 208 is provided with respective identifying information for each microphone 210 and 212, circuitry 214 may signal circuitry 38 in system 206, and may provide this identifying information to circuitry 38. This may result in circuitry 38 signaling PSTN 202, and providing one or more signals to PSTN 202 that may encode this identifying information.

Similarly, in this embodiment, after, prior to, or contemporaneously with establishment of such a teleconference, and after telephone 238 is provided with respective identifying information for each microphone 210 and 212, circuitry 248 may signal circuitry 38′ in system 236, and may provide this identifying information to circuitry 38′. This may result in circuitry 38′ signaling PSTN 202, and providing one or more signals to PSTN 202 that may encode this identifying information.

In response, at least in part to the signaling of PSTN 202 and providing by circuitry 38 and circuitry 38′ to PSTN of these signals encoding this identifying information, PSTN 202 may signal intermediate node 230. This may result in database 234 associating in database 234 the respective channels via which systems 206 and 236 may communicate with PSTN 202 with the respective identifying information provided to PSTN 202 by circuitry 38 and circuitry 38′.

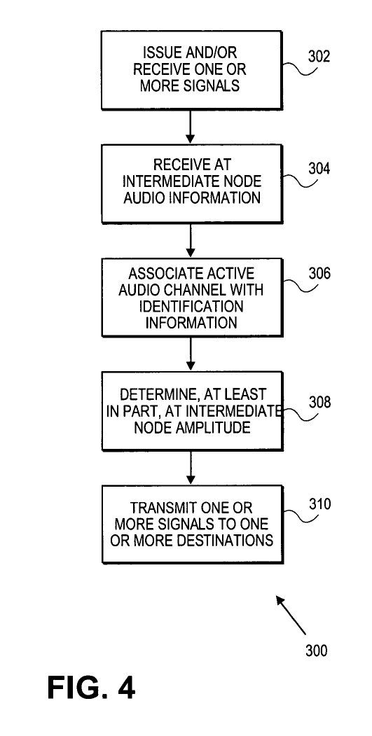

After, prior to, or contemporaneously with the establishment of the teleconference, microphone 212 may generate and transmit to circuitry 214 audio information 216. This may result in circuitry 214 transmitting to circuitry 38 audio information 216 and the identifying information associated with microphone 212. This may result in circuitry 38 generating and issuing to intermediate node 230, and intermediate node 230 in PSTN 202 receiving, one or more signals 226, as illustrated by operations 302 and 304 in FIG. 4. One or more signals 226 may encode audio information 216 and/or an identification of the source of the audio information. For example, if only a single microphone is being used to generate audio information at site 201, then one or more signals 226 may encode only audio information 216. Conversely, if a plurality of microphones are being used to generate audio information at site 201, then one or more signals 226 may encode both audio information 216 and an identification of the source of the audio information. This identification may be based, at least in part, upon identifying information 218 provided at the source. For example, in this embodiment, this identification may comprise identifying information 218.

After intermediate node 230 receives one or more signals 226, node 230 may decode and recover from one or more signals 226 audio information 216 and/or the identification of the source of audio information 216. Intermediate node 230 may associate the identification of the source of the audio information 216 with the active channel via which the audio information was received by intermediate node 230, as illustrated by operation 306 in FIG. 4. For example, in this embodiment, if only a single microphone is being used to generate audio information at site 201, then one or more signals 226 may encode only audio information 216; mixer circuitry 232 may detect the active channel via which one or more signals 226 were received, and after decoding audio information 216 from one or more signals 226, intermediate node 230 may signal database 234. This may result in database 234 retrieving from database 234 the identifying information 218 stored in database 234 that is associated with the active channel via which intermediate node 230 received one or more signals 226, and may also result in database 234 providing identifying information 218 to mixer circuitry 232. Alternatively, if one or more signals 226 encoded both audio information 216 and the identification of the source of audio information 216, this identification may be provided by node 230 to mixer circuitry 232. Alternatively or additionally, database 234 may retrieve identifying information from database 234 based upon which, at least in part, the identification was generated, and may provide this identifying information to mixer circuitry 232. Alternatively or additionally, database 234 may also store in association with this identifying information additional identifying information that may provide additional detail concerning the source of the audio information, and may provide this additional identifying information to mixer circuitry 232.

In this embodiment, using conventional techniques, mixer circuitry 232 may determine the amplitude of audio information 216 (e.g., the amplitude of the one or more audible phenomena that may be represented, at least in part, by the one or more symbols and/or values that may be comprised in the audio information 216, such as, for example, the volume or loudness of the one or more sound waves represented, at least in part, by audio information 216), as illustrated by operation 308 in FIG. 4. Mixer 232 may generate and transmit to one or more destinations one or more signals 228, as illustrated by operation 310. In this embodiment, these one or more destinations may comprise system 236.

In this embodiment, one or more signals 228 may encode audio information 216 and one or more of the following (collectively and/or singly referred to by “information 254” in FIG. 1): the identification of the source of audio information 216 that was encoded in one or more signals 226, identifying information 218, additional identifying information retrieved from database 234, and the amplitude of audio information 216.

After being transmitted from mixer circuitry 232 to system 236, circuitry 38′ in system 236 may receive one or more signals 228. Circuitry 38′ may decode and recover from one or more signals 228 audio information 216, the amplitude of audio information 216, and information 254. Circuitry 38′ may signal circuitry 248, processor 12′ and/or user interface system 16′. This may result in speaker 252 generating the one or more sound waves represented, at least in part, by audio information 216, and user interface system 16′ displaying in visual form that may be appreciated and understood by human user participants of the teleconference at site 204 both an identification of the source of the audio information 216, as indicated and/or specified, for example, by information 254, and an indication of the amplitude of audio information 216.

Operations similar or substantially identical to the foregoing may be utilized in system 200 to provide user-appreciable identification of audio information that may be transmitted from site 204 to site 201 via PSTN 202 during the teleconference. Of course, many modifications, variations, and alternatives are possible without departing from this embodiment.

Thus, one system embodiment may comprise a circuit board comprising a circuit card slot and a circuit card capable of being inserted into the slot. The circuit card of this embodiment may comprise circuitry to at least one of issue and receive one or more signals encoding at least one of audio information and an identification of a source of the audio information. The audio information may be generated, at least in part, at the source. The identification may be generated based, at least in part upon, identifying information provided at the source. Advantageously, these features of this system embodiment may permit confusion during teleconferences carried out using this system embodiment to be reduced. Also advantageously, these features of this system embodiment additionally may permit the teleconference experience to be less frustrating, more productive, and more efficient compared to the prior art.

Various modifications, alternatives, and variations are possible without departing from the above-described embodiments. For example, based at least in part upon the types of information comprised in, for example, information 254, systems 236 and/or 206 may be capable of performing statistical analyses to determine the relative and/or absolute participation amounts and/or frequency of teleconference participants. Additionally, without departing from this embodiment, some or all of the functionality of circuitry 214, 110, 110′, and/or 248 may be comprised network 202. Accordingly, the claims are intended to cover all such equivalents.

1. A method comprising:
at least one of issuing and receiving one or more signals encoding at least one of audio information and an identification of a source of the audio information, the audio information being generated, at least in part, at the source, the identification being generated based, at least in part upon, identifying information provided at the source.

2. The method of claim 1, wherein:
the identifying information comprises at least one of:
an alpha-numeric message entered via a telephone; and
an identification code associated with a device that is capable of wireless communication.

3. The method of claim 1, further comprising:
receiving at an intermediate node the audio information via an active audio channel;
associating the active audio channel with the identification; and
transmitting the one or more signals from the intermediate node to one or more destinations.

4. The method of claim 1, further comprising:
providing, based at least in part upon the identification, at each of one or more destinations of the audio information, a respective user-appreciable identification of the source.

5. The method of claim 1, wherein:
the method further comprises:
receiving at an intermediate node the audio information;
determining, at least in part, at the intermediate node an amplitude of the audio information; and
transmitting from the intermediate node to one or more destinations the one or more signals, the one or more signals also encoding an indication of the amplitude.

6. The method of claim 3, wherein:
a public telephone network comprises the intermediate node; and
the intermediate node comprises:
a database in which to associate the active channel and the identification; and
a mixer to generate the one or more signals.

7. The method of claim 5,wherein:
a public telephone network comprises the intermediate node; and
the intermediate node comprises a mixer to generate the one or more signals.

8. The method of claim 1, wherein:
the source comprises at least one of a computer and a telephone.

9. The method of claim 1, wherein:
the source comprises a microphone communicatively coupled to at least one of the computer and the telephone, the microphone being capable of generating the audio information.

10. An apparatus comprising:
circuitry to at least one of issue and receive one or more signals encoding at least one of audio information and an identification of a source of the audio information, the audio information being generated, at least in part, at the source, the identification being generated based, at least in part upon, identifying information provided at the source.

11. The apparatus of claim 10, wherein:
the identifying information comprises at least one of:
an alpha-numeric message entered via a telephone; and
an identification code associated with a device that is capable of wireless communication.

12. The apparatus of claim 10, also comprising:
an intermediate node capable of receiving the audio information via an active audio channel, the intermediate node also being capable of associating the active audio channel with the identification and of transmitting the one or more signals from the intermediate node to one or more destinations.

13. The apparatus of claim 10, further comprising:
one or more destinations of the audio information capable of providing, based at least in part upon the identification, at each of the one or more destinations, a respective user-appreciable identification of the source.

14. The apparatus of claim 10, also comprising:
an intermediate node capable of receiving the audio information, the intermediate node also being capable of determining, at least in part, an amplitude of the audio information and of transmitting from the intermediate node to one or more destinations the one or more signals, the one or more signals also encoding an indication of the amplitude.

15. The apparatus of claim 12, wherein:
a public telephone network comprises the intermediate node; and
the intermediate node comprises:
a database in which to associate the active channel and the identification; and
a mixer to generate the one or more signals.

16. The apparatus of claim 14, wherein:
a public telephone network comprises the intermediate node; and
the intermediate node comprises a mixer to generate the one or more signals.

17. The apparatus of claim 10, wherein:
the source comprises at least one of a computer and a telephone.

18. The apparatus of claim 10, wherein:
the source comprises a microphone communicatively coupled to at least one of the computer and the telephone, the microphone being capable of generating the audio information.

19. Computer-readable memory having stored therein instructions that when executed by a machine result in the following:
at least one of issuing and receiving one or more signals encoding at least one of audio information and an identification of a source of the audio information, the audio information being generated, at least in part, at the source, the identification being generated based, at least in part upon, identifying information provided at the source.

20. The memory of claim 19, wherein:
the identifying information comprises at least one of:
an alpha-numeric message entered via a telephone; and
an identification code associated with a device that is capable of wireless communication.

21. The memory of claim 19, wherein the instructions when executed by the machine also result in:
receiving at an intermediate node the audio information via an active audio channel;
associating the active audio channel with the identification; and
transmitting the one or more signals from the intermediate node to one or more destinations.

22. The memory of claim 21, wherein the instructions when executed by the machine also result in:
providing, based at least in part upon the identification, at each of one or more destinations of the audio information, a respective user-appreciable identification of the source.

23. The memory of claim 19, wherein the instructions when executed by the machine also result in:
receiving at an intermediate node the audio information;
determining, at least in part, at the intermediate node an amplitude of the audio information; and
transmitting from the intermediate node to one or more destinations the one or more signals, the one or more signals also encoding an indication of the amplitude.

24. The memory of claim 21, wherein:
a public telephone network comprises the intermediate node; and
the intermediate node comprises:
a database in which to associate the active channel and the identification; and
a mixer to generate the one or more signals.

25. The memory of claim 23, wherein:
a public telephone network comprises the intermediate node; and
the intermediate node comprises a mixer to generate the one or more signals.

26. The memory of claim 19, wherein:
the source comprises at least one of a computer and a telephone.

27. The memory of claim 19, wherein:
the source comprises a microphone communicatively coupled to at least one of the computer and the telephone, the microphone being capable of generating the audio information.

28. A system comprising:
a circuit board comprising a circuit card slot;
a circuit card capable of being inserted into the slot, the circuit card comprising circuitry to at least one of issue and receive one or more signals encoding at least one of audio information and an identification of a source of the audio information, the audio information being generated, at least in part, at the source, the identification being generated based, at least in part upon, identifying information provided at the source.

29. The system of claim 28, wherein the circuit board further comprises:
a processor coupled to the slot via a bus.

30. The method of claim 1, further comprising:
displaying at each of one or more destinations of the audio information, a respective user-appreciable identification of the source and a respective user-appreciable indication of the amplitude of the audio information.

31. The apparatus of claim 10, also comprising:
one or more destinations of the audio information capable of displaying a user-appreciable identification of the source and a respective user-appreciable indication of the amplitude of the audio information.

32. The memory of claim 19, wherein the instructions when executed by the machine also result in:
displaying at each of one or more destinations of the audio information, a respective user-appreciable identification of the source and a respective user-appreciable indication of the amplitude of the audio information.
